(19) United States
(12) Patent Application Publication
(10) Pub. No.: US 2023/0103340 A1
(43) Pub. Date: Apr. 6, 2023

(54) INFORMATION GENERATING METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventor: Jun GAO, Shenzhen (CN)

(21) Appl. No.: 18/071,481

(22) Filed: Nov. 29, 2022

Related U.S. Application Data
(63) Continuation of application No. PCT/CN2022/073372, filed on Jan. 24, 2022.

(30) Foreign Application Priority Data
Jan. 29, 2021 (CN) 202110126753.7

(51) Int. Cl. G06V 10/77; G06V 10/44; G06V 10/46; G06V 10/26

(52) U.S. Cl. CPC G06V 10/7715; G06V 10/44; G06V 10/464; G06V 10/26; G06V 10/764

(57) ABSTRACT

An information generating method is performed by a computer device. The method includes: obtaining a target image; extracting a semantic feature set and a visual feature set of the target image; performing attention fusion on semantic features and visual features of the target image at n time steps to obtain caption words of the target image at the n time steps by processing the semantic feature set and the visual feature set of the target image through an attention fusion network in an information generating model; and generating image caption information of the target image based on the caption words of the target image at the n time steps. Through the foregoing method, an advantage of the visual feature in generating visual vocabulary and an advantage of the semantic feature in generating a non-visual feature are combined, thereby improving the image caption's accuracy.

### CROSS-REFERENCE TO RELATED APPLICATIONS

This application is a continuation application of PCT Patent Application No. PCT/CN2022/073372, entitled “INFORMATION GENERATION METHOD AND APPARATUS, DEVICE, STORAGE MEDIUM, AND PROGRAM PRODUCT” filed on Jan. 24, 2022, which claims priority to Chinese Patent Application No. 202110126753.7, filed with the State Intellectual Property Office of the People's Republic of China on Jan. 29, 2021, and entitled “METHOD AND APPARATUS FOR GENERATING IMAGE CAPTION INFORMATION, COMPUTER DEVICE, AND STORAGE MEDIUM”, all of which are incorporated herein by reference in their entirety.

### FIELD OF THE TECHNOLOGY

This application relates to the field of image processing technologies, and in particular, to an information generating method and apparatus, a device, a storage medium, and a program product.

### BACKGROUND OF THE DISCLOSURE

With the development of image recognition technologies, an “image to word” function of a computer can be implemented through algorithm. That is, content information in an image can be converted to image caption information by using a computer device through image caption.

In the related art, it is often focused on generating the image caption information of the image base on extracting a visual feature of the obtained image. That is, after obtaining the visual feature of the image through an encoder, the computer device uses a recurrent neural network to generate overall caption of the image.

### SUMMARY

Embodiments of this application provide an information generating method and apparatus, a device, a storage medium, and a program product. The technical solutions are as follows:

According to an aspect, an information generating method is provided. The method includes:
obtaining a target image;
extracting a semantic feature set of the target image, and extracting a visual feature set of the target image;
performing attention fusion on semantic features of the target image and visual features of the target image at n time steps to obtain caption words at the n time steps by processing the semantic feature set of the target image and the visual feature set of the target image through an attention fusion network in an information generating model; and
generating image caption information of the target image based on the caption words of the target image at n time steps.

According to another aspect, an information generating apparatus is provided. The apparatus includes:
an image obtaining module, configured to obtain a target image;
a feature extraction module, configured to extract a semantic feature set of the target image, and extract a visual feature set of the target image;
a caption word obtaining module, configured to perform attention fusion on semantic features of the target image and visual features of the target image at n time steps to obtain caption words at the n time steps by processing the semantic feature set of the target image and the visual feature set of the target image through an attention fusion network in an information generating model; and
an information generating module, configured to generate image caption information of the target image based on the caption words of the target image at n time steps.

According to another aspect, a computer device is provided, including a processor and a memory, the memory storing at least one computer program, the at least one computer program being loaded and executed by the processor and causing the computer device to implement the information generating method.

According to another aspect, a non-transitory computer-readable storage medium is provided, storing at least one computer program, the computer program being loaded and executed by a processor of a computer device and causing the computer device to implement the information generating method.

According to another aspect, a computer program product is provided, including at least one computer program, the computer program being loaded and executed by a processor of a computer device and causing the computer device to implement the information generating method provided in the various implementations.

The technical solutions provided in this application may include the following beneficial effects:

Attention fusion of semantic features and visual features of the target image at n time steps is implemented by extracting a semantic feature set and a visual feature set respectively. Therefore, at each time step of generating image caption information, based on a comprehensive effect of an output result of visual features and semantic features of the target image at a previous time step, a computer device generates a caption word of a target image at a current time step, and further generates image caption information corresponding to the target image. At a process of generating image caption information, an advantage of the visual feature in generating a visual vocabulary and an advantage of the semantic feature in generating a non-visual feature are complemented, to improve accuracy of generating image caption information.

### BRIEF DESCRIPTION OF THE DRAWINGS

FIG. 1 is a schematic diagram of a system used in an information generating method according to an exemplary embodiment of this application.

FIG. 2 is a flowchart of an information generating method according to an exemplary embodiment of this application.

FIG. 3 is a schematic diagram of extracting word information in images based on different attention according to an exemplary embodiment of this application.

FIG. 4 is a schematic diagram of a target image selection corresponding to a video scenario according to an exemplary embodiment of this application.

FIG. 5 is a frame diagram of a model training stage and an information generating stage according to an exemplary embodiment.

FIG. 6 is a flowchart of a training method of an information generating model according to an exemplary embodiment of this application.

FIG. 7 is a flowchart of model training and an information generating method according to an exemplary embodiment of this application.

FIG. 8 is a schematic diagram of a process of generating image caption information according to an exemplary embodiment of this application.

FIG. 9 is a schematic diagram of input and output of an attention fusion network according to an exemplary embodiment of this application.

FIG. 10 is a frame diagram of an information generating apparatus according to an exemplary embodiment of this application.

FIG. 11 is a structural block diagram of a computer device according to an exemplary embodiment of this application.

FIG. 12 is a structural block diagram of a computer device according to an exemplary embodiment of this application.

### DESCRIPTION OF EMBODIMENTS

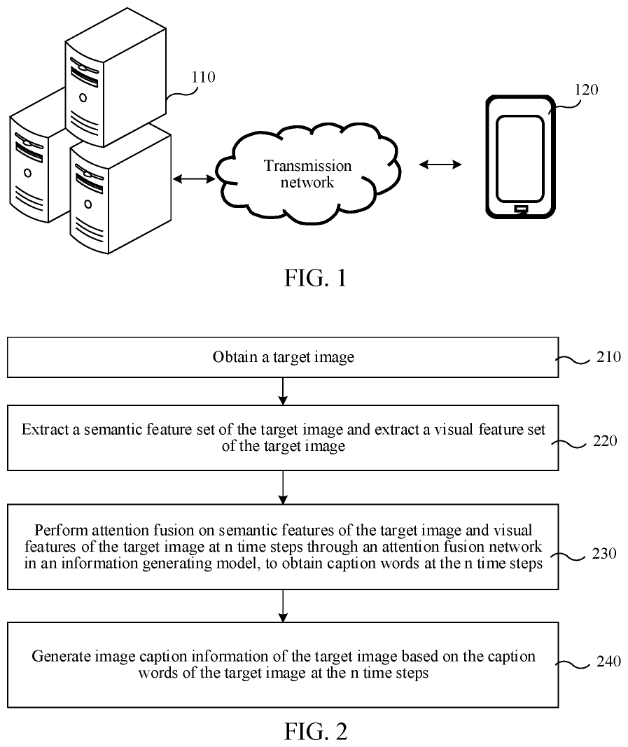

FIG. 1 is a schematic diagram of a system used in an information generating method according to an exemplary embodiment of this application, and as shown in FIG. 1, the system includes: a server 110 and a terminal 120.

The server 110 may be an independent physical server, or may be a server cluster including a plurality of physical servers or a distributed system.

The terminal 120 may be a terminal device having a network connection function and image display function and/or video play function. Further, the terminal may be a terminal having a function of generating image caption information, for example, the terminal 120 may be a mobile phone, a tablet computer, an e-book reader, smart glasses, a smartwatch, a smart television, a moving picture experts group audio layer III (MP3) player, a moving picture experts group audio layer IV (MP4) player, a laptop portable computer, a desktop computer, or the like.

In some embodiments, the system includes one or more servers 110 and a plurality of terminals 120. A number of the server 110 and the terminal 120 is not limited in the embodiments of this application.

The terminal may be connected to the server through a communication network. In some embodiments, the communication network is a wired network or a wireless network.

In an embodiment of this application, a computer device can obtain a target image; extract a semantic feature set of the target image and a visual feature set; perform attention fusion on semantic features of the target image and visual features of the target image at n time steps to obtain caption words at the n time steps by processing the semantic feature set of the target image and the visual feature set of the target image through an attention fusion network in an information generating model, input of the attention fusion process at a t^{th} time step including a semantic attention vector at the t^{th} time step, a visual attention vector at the t^{th} time step, and an output result of the attention fusion process at a (t−1)^{th} time step, the semantic attention vector at the t^{th} time step being obtained by performing attention mechanism processing on the semantic feature set at the t^{th} time step, the visual attention vector at the t^{th} time step being obtained by performing the attention mechanism processing on the visual feature set at the t^{th} time step, the output result of the attention fusion process at the (t−1)^{th} time step being used for indicating a caption word at the (t−1)^{th} time step, the t^{th} time step being any one of the n time steps, 1≤t≤n, and t and n being positive integers; and generate image caption information of the target image based on the caption words of the target image at the n time steps. By using the foregoing method, the computer device can perform attention fusion on the visual features and the semantic features of the target image at a process of generating the image caption information at any time step, to complement an advantage of the visual feature in generating visual vocabulary and an advantage of the semantic feature in generating a non-visual feature, to improve accuracy of generating the image caption information.

In some embodiments, a computer device can perform attention fusion on the semantic features and the visual features of the target image through an attention fusion network in an information generating model, to obtain caption words at each time step. Based on this, FIG. 2 is a flowchart of an information generating method according to an exemplary embodiment of this application. The method may be performed by a computer device, the computer device may be a terminal or a server, and the terminal or the server may be the terminal or server in FIG. 1. As shown in FIG. 2, the information generating method may include the following steps:

Step 210. Obtain a target image.

In a possible implementation, the target image may be an image locally stored, or an image obtained in real time based on a specified operation of a target object. For example, the target image may be an image obtained in real time based on a screenshot operation by the target object; or, the target image may further be an image on a terminal screen acquired in real time by the computer device when the target object triggers generation of the image caption information by long pressing a specified region on the screen; or, the target image may further be an image obtained in real time by an image acquisition component based on the terminal. A method for obtaining the target image is not limited in this application.

Step 220. Extract a semantic feature set of the target image and extract a visual feature set of the target image.

The semantic feature set of the target image is used for indicating a word vector set corresponding to candidate caption words of image information describing the target image.

The visual feature set of the target image is used for indicating a set of image features obtained based on an RGB (red, green, and blue) distribution and other features of pixels of the target image.

Step 230. Perform the attention fusion on the semantic features of the target image and the visual features of the target image at the n time steps through the attention fusion network in the information generating model to obtain the caption words at the n time steps by processing the semantic feature set of the target image and the visual feature set of the target image through an attention fusion network in an information generating model.

Corresponding to the above attention fusion process, input of the attention fusion network process at a t^{th} time step including a semantic attention vector at the t^{th} time step, a visual attention vector at the t^{th} time step, and an output result of the attention fusion network process at a (t−1)^{th} time step. The semantic attention vector at the t^{th} time step is obtained by performing attention mechanism processing on the semantic feature set at the t^{th} time step, the visual attention vector at the t^{th} time step is obtained by performing the attention mechanism processing on the visual feature set at the t^{th} time step, the output result of the attention fusion network at the (t−1)^{th} time step is used for indicating a caption word at the (t−1)^{th} time step, the t^{th} time step is any one of then time steps, 1≤t≤n, and t and n are positive integers.

A number n of the time steps represents a number of the time steps required to generate the image caption information of the target image.

Essentially, an attention mechanism is a mechanism through which a set of weight coefficients is learned autonomously through the network, and a region in which the target object is interested is emphasized, while an irrelevant background region is suppressed in a “dynamic weighting” manner. In the field of computer vision, the attention mechanism can be broadly divided into two categories: hard attention and soft attention.

The attention mechanism is often applied to a recurrent neural network (RNN). When RNN with the attention mechanism processes some pixels of the target image each time, it will process the partial pixels of the target image concerned in a previous state of a current state instead of all the pixels of the target image, to reduce processing complexity of a task.

In this embodiment of this application, when generating image caption information, after the computer device generates a word, the computer device generates a next word based on the generated word. Time required to generate a word is called a time step. In some embodiments, the number n of time steps may be a non-fixed value greater than one. The computer device ends a generation process of the caption words in response to a generated caption word being a word or a character indicating an end of the generation process of the caption words.

The information generating model in the embodiment of this application is configured to generate the image caption information of an image. The information generating model is generated by training a sample image and the image caption information corresponding to the sample image, and the image caption information of the sample image may be text information.

In an embodiment of this application, the semantic attention vector can enhance a generation of visual caption words and non-visual caption words simultaneously by using multiple attributes. The visual caption words refer to caption word information extracted directly based on pixel information of the images, for example, caption words with noun part of speech in the image caption information; and The non-visual caption words refer to caption word information extracted with low probabilities based on the pixel information of the images, or caption word information cannot be extracted directly, for example, caption words with verb or preposition parts of speech in the image caption information.

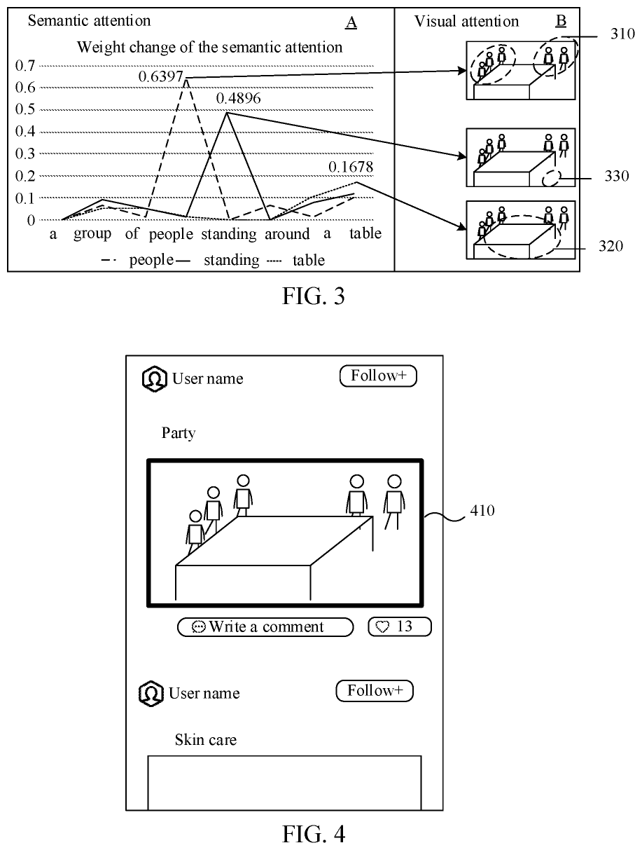

The visual attention vector can enhance the generation of visual caption words and has a good performance in extracting visual caption words of the images. FIG. 3 is a schematic diagram of extracting word information in images based on different attention according to an exemplary embodiment of this application. As shown in FIG. 3, part A in FIG. 3 shows a weight change of each caption word obtained by a specified image under an effect of a semantic attention mechanism, and part B in FIG. 3 shows a weight change of each caption word obtained by the same specified image under an effect of a visual attention mechanism. Using the caption words as an example, for three words “people”, “standing” and “table”, under the semantic attention mechanism, a weight of each word reaches a peak at the moment when each word is generated, that is, the semantic attention mechanism focuses on a word with the highest relevance to a current context. Under the visual attention mechanism, when generating a visual word among three words, that is, when generating “people” and “table”, visual attention focuses on an image are corresponding to the visual word in the specified image. Schematically, as shown in FIG. 3, when generating “people”, the visual attention will focus on a region 310 containing a face in the specified image. When the non-visual word among the three words are generated, that is, when generating “table”, visual attention focuses on a region 320 containing a table in the specified image; and But when generating non-visual words based on the visual attention mechanism, for example, when generating “standing”, the visual attention mechanism focuses on an irrelevant, potentially misleading image are 330.

Therefore, in order to combine an advantage of the visual attention mechanism in generating visual words and an advantage of the semantic attention mechanism in generating non-visual words, in the embodiment of this application, a combination of the visual attention and the semantic attention enables the computer device more accurate in guiding the generation of visual words and non-visual words, and reducing the interference of the visual attention in the generation of non-visual words, so that generated image caption is more complete and substantial.

Step 240. Generate the image caption information of the target image based on the caption words of the target image at n time steps.

In a possible implementation, the caption words on the n time steps are sorted in a specified order, such as sequential order, to generate image caption information of the target image.

To sum up, according to the information generating method provided in the embodiments of this application, by respectively extracting the semantic feature set and the visual feature set of the target image, and using the attention fusion network in the information generating model, the attention fusion of the semantic features and the visual features is implemented, so that at each time step of generating the image caption information, the computer device can generate the caption word of the target image at the current time step, and further generate the image caption information of the target image based on the visual features and the semantic features of the target image and in combination with the output result of the previous time step. In addition, at a process of generating image caption information, an advantage of visual features in generating visual vocabulary and an advantage of semantic features in generating a non-visual feature are complemented, to improve accuracy of generating image caption information.

Schematically, the method in this embodiment of this application may be applied to, but is not limited to, the following scenarios.

1. Scenarios for visually impaired people to obtain image information.

A visual function of the visually impaired people (that is, those with visual impairment) cannot achieve normal vision due to reduced visual acuity or impaired visual field, which affects the visually impaired people's access to visual information. For example, when the visually impaired people use a mobile phone to view pictures, texts or videos, since complete visual information content cannot be obtained, they need to use hearing to obtain information in an image; and a possible way is that the target object generates image caption information corresponding to a region by selecting a region or a region range of the content to be viewed and using the information generating method in the embodiment of this application, and converts the image caption information by text information into audio information for playback, thereby assisting the visually impaired people to obtain complete image information.

FIG. 4 is a schematic diagram of a target image selection corresponding to a video scenario according to an exemplary embodiment of this application. As shown in FIG. 4, the target image may be an image obtained by a computer device from a video in playback based on a received specified operation on the video in playback. Alternatively, the target image may also be an image obtained by the computer device from a dynamic image of a live broadcast room displayed in a live broadcast preview interface in real time, based on a received specified operation on the dynamic image; and the dynamic image displayed in the live broadcast preview interface is used for assisting a target object to make a decision whether to enter the live broadcast room for viewing by previewing a real-time content in the live broadcast room.

In a possible implementation, the target object can click (specify the operation) a certain are of a video image or a dynamic image to determine a current image in the region (the image received at the time of the click action) as the target image.

In order to enhance selection of the target image by the target object, the selected region based on the specified operation can be highlighted, for example, highlighted display, or enlarged display, or bold display of borders, and the like. As shown in FIG. 4, a region 410 is displayed in bold.

2. Early education scenarios.

In the early education scenarios, due to a limited range of children's cognition of objects or words, teaching through images will have a better teaching effect. In this scenario, the information generating method shown in this application can be used for describing image information of an image touched by a child, so as to transmit information to the child from both visual and auditory directions, stimulate the child's interest in learning, and improve information transmission effect.

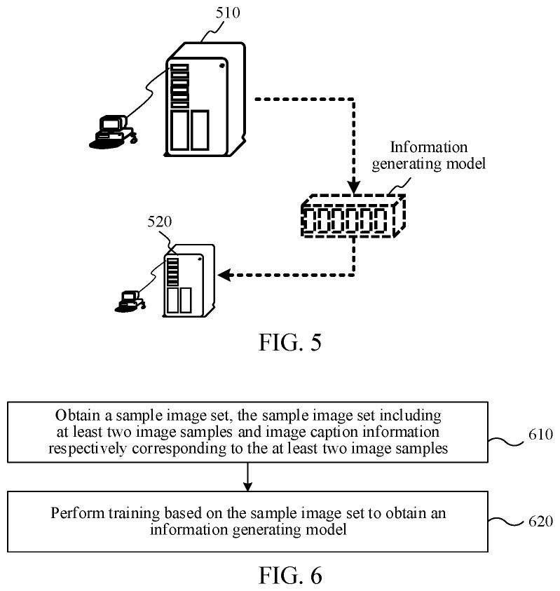

The method of this application includes a model training stage and an information generating stage. FIG. 5 is a frame diagram of a model training stage and an information generating stage according to an exemplary embodiment. As shown in FIG. 5, in the model training stage, a model training device 510 uses preset training samples (including sample images and image caption information corresponding to the sample images. Schematically, the image caption information may be a sequence of caption words) to obtain a visual-semantic double attention (VSDA) model, that is, an information generating model. The visual-semantic double attention model includes a semantic attention network, a visual attention network and an attention fusion network.

In the information generating stage, an information generating device 520 processes an input target image based on the visual-semantic double attention model to obtain image caption information corresponding to the target image.

The model training device 510 and information generating device 520 may be computer devices, for example, the computer devices may be fixed computer devices such as personal computers and servers, or the computer devices may also be mobile computer devices such as tablet computers, e-book readers, and the like.

In some embodiments, the model training device 510 and the information generating device 520 may be the same device, or the model training device 510 and the information generating device 520 may also be different devices. Moreover, when the model training device 510 and the information generating device 520 are different devices, the model training device 510 and the information generating device 520 may be the same type of device, for example, the model training device 510 and the information generating device 520 may both be servers. Alternatively, the model training device 510 and the information generating device 520 may also be different types of devices, for example, the information generating device 520 may be a personal computer or a terminal, and the model training device 510 may be a server and the like. Specific types of the model training device 510 and the information generating device 520 are not limited in the embodiments of this application.

FIG. 6 is a flowchart of a training method of an information generating model according to an exemplary embodiment of this application. The method may be performed by a computer device, the computer device may be a terminal or a server, and the terminal or the server may be the terminal or server in FIG. 1. As shown in FIG. 6, the training method for the information generating model includes the following steps:

Step 610. Obtain a sample image set, the sample image set including at least two image samples and image caption information respectively corresponding to the at least two image samples.

Step 620. Perform training based on the sample image set to obtain an information generating model.

The information generating model can be a visual-semantic double attention model, including a semantic attention network, a visual attention network, and an attention fusion network. The semantic attention network is used for obtaining a semantic attention vector based on a semantic feature set of an image, and the visual attention network is used for obtaining visual attention vectors based on a visual feature set of the image. The attention fusion network is used for performing attention fusion on semantic features and visual features of the image, to obtain the caption words composing the image caption information corresponding to the image.

To sum up, according to the training method for the information generating model provided in the embodiment of this application, the information generating model including the semantic attention network, the visual attention network and the attention fusion network is obtained based on the training of the sample image set. Therefore, in the process of generating the image caption information, by using the information generating model, a caption word of the target image at a current time step can be generated based on a comprehensive effect of an output result of visual features and semantic features of the target image at a previous time step, to further generate the image caption information corresponding to the target image, so that in the generating process of the image caption information, the advantage of the visual features in generating visual vocabulary and the advantage of the semantic features in generating a non-visual feature are complemented, thereby improving accuracy of the generation of image caption information.

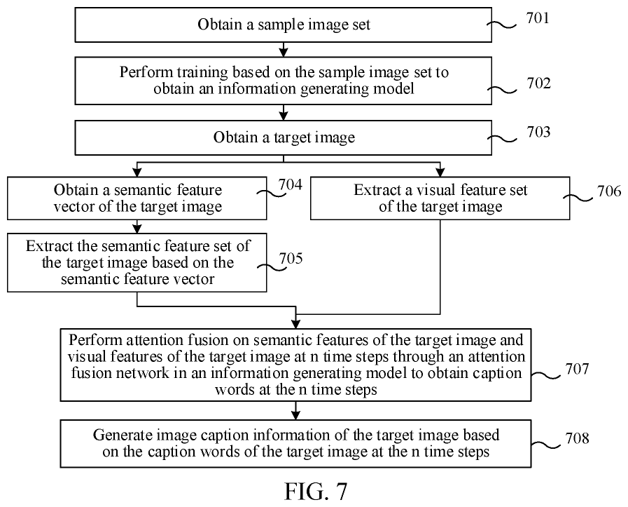

In an embodiment of this application, a model training process may be performed by a server, and a generating process of image caption information may be performed by a server or a terminal. When the generating process of the image caption information is performed by the terminal, the server sends the trained visual-semantic double attention model to the terminal, so that the terminal can process the acquired target image based on the visual-semantic double attention model to obtain image caption information of the target image. The following embodiment uses the model training process and the generating process of the image caption information performed by the server as an example for description. FIG. 7 is a flowchart of model training and an information generating method according to an exemplary embodiment of this application and the method can be performed by a computer device. As shown in FIG. 7, the model training and the information generating method can include the following steps:

Step 701. Obtain a sample image set, the sample image set including at least two image samples and image caption information respectively corresponding to the at least two image samples.

The image caption information corresponding to each sample image may be marked by a related person.

Step 702. Perform training based on the sample image set to obtain an information generating model.

The information generating model is a visual-semantic double attention model, including a semantic attention network, a visual attention network, and an attention fusion network. The semantic attention network is used for obtaining a semantic attention vector based on a semantic feature set of a target image, and the visual attention network is used for obtaining visual attention vectors based on a visual feature set of the target image. The attention fusion network is used for performing attention fusion on semantic features and visual features of the target image, to obtain the caption words including the image caption information corresponding to the target image.

In a possible implementation, the information generating model further includes a semantic convolutional neural network and a visual convolutional neural network. The semantic convolutional neural network is used for processing the target image to obtain a semantic feature vector of the target image, to obtain a caption word set of the target image. The visual convolutional neural network is used for processing the target image to obtain a visual feature set of the target image.

In a possible implementation, the training process of the information generating model is implemented by:
inputting each sample image in the sample image set into the information generating model to obtain predicted image caption information corresponding to the each sample image;
calculating a loss function value based on the predicted image caption information corresponding to the each sample image and the image caption information corresponding to the each sample image; and
updating an information generating model parameter based on the loss function value.

Since it is needed that an output result of the information generating model based on the sample images (that is, the predicted image caption information) is similar to the image caption information corresponding to the sample images, to ensure accuracy of the image caption information of the target images can be generated by the information generating model. Therefore, it is necessary to perform a plurality of times of training in the training process of the information generating model and update each parameter of each network in the information generating model until the information generating model converges.

Let θ represent all parameters involved in the information generating model. Preset a ground truth sequence {w₁, w₂, . . . , wₜ}, that is, a sequence of caption words in the image caption information of the sample images. The loss function is a minimization cross entropy loss function. The formula for calculating the loss function value corresponding to the information generating model can be expressed as:

$$L ( θ ) = - {\sum }_{t = 1}^{T} log ( {p}_{θ} ( {w}_{t}^{*} \vert {w}_{1}^{*} , … , {w}_{t - 1}^{*} ) )$$

In the above formula, p_{θ}(wₜ^{*}|w₁^{*}, . . . , wₜ₋₁^{*}) represents a probability of each caption word in the predicted image caption information outputted by the information generating model. Adjust each parameter in each network in the information generating model based on a calculation result of the loss function.

Step 703. Obtain a target image.

The generating process in response to the image caption information is performed by the server. The target image may be an image transmitted to the server for obtaining the image caption information from the obtained target image of the terminal, and correspondingly, the server receives the target image.

Step 704. Obtain a semantic feature vector of the target image.

In a possible implementation, the target image is inputted into the semantic convolutional neural network, to obtain the semantic feature vector of the target image output by the semantic convolutional neural network.

The semantic convolutional neural network may be a fully convolutional network (FCN), or may also be a convolutional neural network (CNN). CNN is a feedforward neural network, which is a neural network with a one-way multi-layer structure. Neurons in a same layer are not connected with each other, and information transmission between layers is only carried out in one direction. Except for an input layer and an output layer, all middle layers are hidden layers, and the hidden layers are one or more layers. CNN can directly start from pixel features at a bottom of the image and extract image features layer by layer. CNN is a most commonly used implementation model for an encoder, and is responsible for encoding an image into a vector.

By processing the target image through the semantic convolutional neural network, the computer device can obtain a rough graph representing a vector of the target image, that is, the semantic feature vector of the target image.

Step 705. Extract the semantic feature set of the target image based on the semantic feature vector.

In a lexicon, not all attribute words correspond to the target image. If all words in the lexicon are calculated or verified in probability, excessive and unnecessary data processing will be caused. Therefore, before obtaining a caption word set, the computer device can first filter the attribute words in the lexicon based on the obtained semantic feature vector indicating attributes of the target image, obtain an attribute word set composed of the attribute words that may correspond to the target image, that is, a candidate caption word set, and then extract the semantic features of the attribute words in the candidate caption word set to obtain the semantic feature set of the target image.

In a possible implementation, the computer device can extract the attribute word set corresponding to the target image from the lexicon based on the semantic feature vector. The attribute word set refers to the candidate caption word set describing the target image, and
a word vector set corresponding to the attribute word set is obtained as the semantic feature set of the target image. The word vector set includes word vectors corresponding to each candidate caption word in the attribute word set.

The candidate caption words in the attribute word set are attribute words corresponding to a context of the target image. A number of the candidate caption words in the attribute word set is not limited in this application

The candidate caption words can include different forms of the same word, such as: play, playing, plays and the like.

In a possible implementation, a matching probability of each word can be obtained, and the candidate caption words are selected from the lexicon based on the matching probability of each word to form the attribute word set. The process can be implemented as follows:

Obtain a matching probability of each word in the lexicon based on the semantic feature vector, the matching probability referring to a probability that the word in the lexicon matches the target image.

In the lexicon, extract words with matching probability greater than a matching probability threshold as candidate caption words to form the attribute word set.

In a possible implementation, the probability of each attribute word in the image can be calculated through a Noise-OR method. In order to improve accuracy of obtained attribute words, the probability threshold can be set to 0.5. It is to be understood that, a setting of the probability threshold can be adjusted according to an actual situation, and this is not limited in this application.

In order to improve the accuracy of the obtained attribute word, in a possible implementation, a vocabulary detector may be pre-trained, and the vocabulary detector is configured to obtain the attribute words from the lexicon based on a feature vector of the target image. Therefore, the computer can obtain the attribute words by using a trained vocabulary detector, that is:

Input the feature vector into the vocabulary detector, so that the vocabulary detector extracts the attribute words from the lexicon based on the feature vector.

In some embodiments, the vocabulary detector is a vocabulary detection model obtained by training with a weak supervision method of multiple instance learning (MIL).

Step 706. Extract the visual feature set of the target image.

In a possible implementation, the computer device can input the target image into the visual convolutional neural network, and obtain the visual feature set of the target image outputted by the visual convolutional neural network.

In order to improve the accuracy of the obtained visual feature set, in a possible implementation, before extracting the visual feature set of the target image, the computer device may preprocess the target image, and the preprocessing process may include the following steps:
dividing the target image into sub-regions to obtain at least one sub-region.

In this case, a process of extracting the visual feature set of the target image can be implemented as:
respectively extracting the visual features of the at least one sub-region to form the visual feature set.

The computer device can divide the target image equally spaced to obtain the at least one sub-region. The division spacing may be set by the computer device based on an image size of the target image, and the division spacing corresponding to different image sizes is different. A number of sub-regions and a size of the division spacing are not limited in this application.

In an embodiment of this application, the process of extracting the semantic feature set of the target object and the process of extracting the visual feature set of the target object can be performed synchronously, that is, steps 704 to 705 and step 706 can be performed synchronously.

Step 707. Perform the attention fusion on the semantic features of the target image and the visual features of the target image at the n time steps through the attention fusion network in the information generating model to obtain the caption words at the n time steps by processing the semantic feature set of the target image and the visual feature set of the target image through an attention fusion network in an information generating model.

Using a t^{th} time step among the n time steps as an example, the process of obtaining the caption word on the t^{th} time step can be implemented as:
inputting, at the t^{th} time step, the semantic attention vector at the t^{th} time step, the visual attention vector at the t^{th} time step, a hidden layer vector at the (t−1)^{th} time step, and an output result of the attention fusion network at the (t−1)^{th} time step into the attention fusion network, to obtain an output result of the attention fusion network at the t^{th} time step and a hidden layer vector at the t^{th} time step;
or,
inputting, at the t^{th} time step, the semantic attention vector at the t^{th} time step, the visual attention vector at the t^{th} time step, and an output result of the attention fusion network at the (t−1)^{th} time step into the attention fusion network, to obtain the output result of the attention fusion network at the t^{th} time step and the hidden layer vector at the t^{th} time step.

In other words, in a possible implementation, a semantic attention vector and a visual attention vector can be applied to an output result at a previous time step to obtain an output result at a current time step. Alternatively, in another possible implementation, in order to improve the accuracy of the obtained output results at each time step, the semantic attention vector, the visual attention vector, and a hidden layer vector at the previous time step can be applied to the output result at the previous time step, to obtain the output result at the current time step. The output result at the current time step is a word vector of a caption word at the current time step.

In order to obtain the caption words of the target image at each time step, it is necessary to obtain the attention vectors of the target image at each time step, and the attention vectors include the semantic attention vector and the visual attention vector.

Using the t^{th} time step as an example, when the semantic attention vector is obtained, at the t^{th} time step, the semantic attention vector at the t^{th} time step is generated based on the hidden layer vector at the (t−1)^{th} time step and the semantic feature set of the target image.

The hidden layer vectors indicate the intermediate content generated when the caption words are generated, and the hidden layer vectors include historical information or context information used for indicating generation of a next caption word, so that the next caption word generated at a next time step is more in line with a current context.

The t^{th} time step represents any time step among the n time steps, n represents a number of time steps required to generate image caption information, 1≤t≤n, and t and n are positive integers.

When generating the semantic attention vector at the current time step, the information generating model can generate the semantic attention vector at the current time step based on the hidden layer vector at the previous time step and the semantic feature set of the target image.

In a possible implementation, the information generating model can input the hidden layer vector outputted at the (t−1)^{th} time step and the semantic feature set of the target image into the semantic attention network in the information generating model to obtain the semantic attention vector outputted by the semantic attention network at the t^{th} time step.

The semantic attention network is used for obtaining weights of each semantic feature in the semantic feature set at the (t−1)^{th} time step based on the hidden layer vector at the (t−1)^{th} time step and the semantic feature set of the target image.

The information generating model can generate a semantic attention vector at the t^{th} time step based on the weights of each semantic feature in the semantic feature set at the (t−1)^{th} time step and the semantic feature set of the target image.

A semantic attention vector at each time step is a weight sum of each attribute word, and the calculation formula is:

$${c}_{t} = {b}_{i} \cdot {h}_{t - 1}$$

$${β}_{t} = softmax ( {c}_{t} )$$

$${A}_{t} = {\sum }_{i = 1}^{L} {β}_{ti} \cdot {b}_{i}$$

bᵢ={b₁, . . . , b_{L}} represents attributes obtained from the target image; L represents a length of the attribute, that is, a number of attribute words; bᵢ represents the word vectors of each attribute word; cₜ represents a long-term memory vector; hₜ₋₁ represents the hidden layer vector at the (t−1)^{th} time step; βₜ represents the each weight of each attribute word at the t^{th} time step; and Aₜ represents the semantic attention vector at the t^{th} time step.

Using the t^{th} time step as an example, when obtaining the visual attention vector: at the t^{th} time step, the visual attention vector at the t^{th} time step is generated based on the hidden layer vector at the (t−1)^{th} time step, and the visual feature set.

When generating the visual attention vector at the current time step, the information generating model can generate the visual attention vector at the current time step based on the hidden layer vector outputted at the previous time step and the visual feature set of the target image.

In a possible implementation, the information generating model can input the hidden layer vector outputted at the (t−1)^{th} time step and the visual feature set of the target image into the visual attention model in the information generating model to obtain the visual attention vector outputted by the visual attention model at the t^{th} time step.

The visual attention model is used for obtaining weights of each visual feature in the visual feature set at the (t−1)^{th} time step based on the hidden layer vector at the (t−1)^{th} time step and the visual feature set.

The information generating model can generate the visual attention vector at the t^{th} time step based on the weights of each visual feature in the visual feature set at the (t−1)^{th} time step and the visual feature set.

The visual attention vectors at each time step is the weight sum of the visual features of each sub-region, and the calculation formula is:

$${α}_{t} = softmax ( {a}_{i} \cdot {h}_{t - 1} )$$

$${V}_{t} = {\sum }_{i = 1}^{m} ( {α}_{ti} \cdot {a}_{i} )$$

aᵢ={a₁, . . . , aₘ} represents the visual features of each sub-region to indicate a focal region of the target image; m represents a number of sub-regions, that is, a number of extracted visual features; αₜ represents the weights corresponding to each visual feature; and Vₜ represents the visual attention vector at the t^{th} time step.

When calculating the weights corresponding to the visual features of each sub-region, the information generating model can be calculated through the element-wise multiplication strategy to obtain better performance.

Since the attention model can capture more detailed image features of sub-regions, when generating the caption words of different objects, a soft attention mechanism can adaptively focus on corresponding regions, and the performance is better. Therefore, the visual attention model based on the soft attention mechanism is adopted in the embodiment of this application.

The visual attention model and the semantic attention model calculate the weights of the corresponding feature vectors at each time step. Since the hidden layer vectors at different time steps are different, the weights of each feature vector obtained at each time step is also different. Therefore, at each time step, the information generating model can focus on image focal regions that are more in line with the context at each time step and feature words for generating image caption.

In a possible implementation, the attention fusion network in the information generating model may be implemented as a sequence network, and the sequence network can include long short term memory (LSTM), Transformer network, and the like. The LSTM is a time recurrent neural network used for predicting important time having an interval or delay for a relatively long time in a time sequence, and is a special RNN.

Using the sequence network being the LSTM network as an example, when generating image caption information, a visual attention vector V and a semantic attention vector A are used as additional input parameters of the LSTM network, and these two attention feature sets are merged into the LSTM network to guide the generation of the image caption information, and guide the information generating model to pay attention to the visual features and the semantic features of the image at the same time, so that the two feature vectors complement each other.

In an embodiment of this application, a BOS and EOS notation can be used for representing a beginning and an end of the statement respectively. Based on this, the formula for the LSTM network to generate caption words based on the visual attention vector and the semantic attention vector is as follows:

xₜ=E1_{w}_{_{t−1}} for t [symbol] 1,w₀=BOS

iₜ=σ(Wᵢₓxₜ+Wᵢₕhₜ₋₁+bᵢ)

fₜ=σ(W_{fx}xₜ+W_{fh}hₜ₋₁+b_{f})

oₜ=σ(Wₒₓxₜ+Wₒₕhₜ₋₁+bₒ)

cₜ=iₜ⊙ϕ(W_{cx}^{⊗}xₜ+W_{ch}^{⊗}hₜ₋₁+W_{cV}^{⊗}Vₜ+W_{cA}^{⊗}Aₜ+b_{c})+fₜ⊙cₜ₋₁

hₜ=oₜ⊙tanh (cₜ)

sₜ=Wₛhₜ

σ represents a sigmoid function. ϕ represents a maxout nonlinear activation function with two units (⊗ represents the unit). iₜ represents an input gate, fₜ represents a forget gate, and oₜ represents an output gate.

The LSTM uses a softmax function to output a probability distribution of the

next word:

wₜ˜softmax(sₜ)

In a possible implementation, the attention fusion network in the information generating model is provided with a hyperparameter, the hyperparameter being used for indicating the weights of the visual attention vector and the semantic attention vector respectively in the attention fusion network.

Since the visual attention features and the semantic attention features, during the generation of image caption information, will affect the generation of the image caption information by the information generating model in different aspects, the visual attention vector V guides the model to pay attention to relevant regions of the image, and the semantic attention vector A strengthens the generation of a most relevant attribute words. Given that these two attention vectors are complementary to each other, an optimal combination between the two attention vectors can be determined by setting a hyperparameter in the attention fusion network. Still using the attention fusion network being an LSTM network as an example, the updated LSTM network to generate caption words based on the visual attention vector and the semantic attention vector is as follows:

xₜ=E1_{w}_{_{t−1}} for t [symbol] 1,w₀=BOS

iₜ=σ(Wᵢₓxₜ+Wᵢₕhₜ₋₁+bᵢ)

fₜ=σ(W_{fx}xₜ+W_{fh}hₜ₋₁+b_{f})

oₜ=σ(Wₒₓxₜ+Wₒₕhₜ₋₁+bₒ)

cₜ=iₜ⊙ϕ(W_{cx}^{⊗}xₜ+W_{ch}^{⊗}hₜ₋₁+z·W_{cV}^{⊗}Vₜ+(1−z)·W_{cA}^{⊗}Aₜ+b_{c})+fₜ⊙cₜ₋₁

hₜ=oₜ⊙tanh (cₜ)

sₜ=Wₛhₜ

z represents a hyperparameter, and its value range is [0.1, 0.9], which is used for representing the different weights of the two attention vectors. The larger Z is, the greater the weight of visual features in attention guidance is, and the smaller the weight of semantic features in attention guidance is. Otherwise, the smaller z is, the greater the weight of semantic features in attention guidance is, and the smaller the weight of visual features in attention guidance is.

It is to be understood that, value setting of the hyperparameter can be set according to a performance effect of the model under different weight allocation. A value size of the hyperparameter is not limited in this application.

Step 708. Generate the image caption information of the target image based on the caption words of the target image at n time steps.

In a possible implementation, the image caption information generated by the information generating model is caption information in a first language, for example, the first language may be English, or Chinese, or other languages.

In order to make the image caption information more adaptable to using requirements of different objects, in a possible implementation, in response to the generated language of the target image caption information being a non-specified language, the computer device can convert the generated caption information in the first language to the caption information in a specified language. For example, the image caption information generated by the information generating model is caption information in English, and the specified language required by the target object is Chinese, then after the information generating model generates the English image caption information, the computer device can translate the English image caption information to Chinese image caption information. After describing the information for the Chinese image and output.

A language type of the outputted image caption information, that is, the type of the specified language can be set by the relevant object according to actual requirements. The language type of the image caption information is not limited in this application.

In a possible implementation, since the generated image caption information is text information, in order to facilitate the target object to receive the image caption information, the computer device can convert text type image caption information into voice type image caption information based on the text-to-speech (TTS) technology, and transmit the image caption information to the target object in a form of voice playback.

The above process can be implemented as: after the server converts the obtained text type image caption information into voice type image caption information through TTS technology, the voice type image caption information is transmitted to the terminal, so that the terminal can play the image caption information according to the acquired voice type image caption information. Or, the server may also transmit text type image caption information to the terminal, and the terminal performs voice playback after converting the text type image caption information into the voice type image caption information through TTS technology.

To sum up, according to the model training and the information generating method provided in the embodiments of this application, by respectively extracting the semantic feature set and the visual feature set of the target image, and using the attention fusion network in the information generating model, the attention fusion of the semantic features and the visual features is implemented, so that at each time step of generating the image caption information, based on a comprehensive effect of an output result of visual features and semantic features of the target image at a previous time step, the caption words of the target image at the current time step are generated, and the image caption information of the target image is further generated. In a process of generating the image caption information, the advantage of the visual features in generating visual vocabulary and the advantage of the semantic features in generating a non-visual feature are enabled to be complemented at the process of generating the caption information, to improve accuracy of generating the image caption information.

At the same time, before the semantic attention network obtains the weights of each attribute word, by screening the words in the lexicon are based on the feature vector of the image, the attribute words related to the image are obtained as the candidate caption words. The weight is calculated based on the candidate caption words, thereby reducing the data processing load of the semantic attention network, and reducing the data processing pressure of the information generating model while ensuring the processing accuracy.

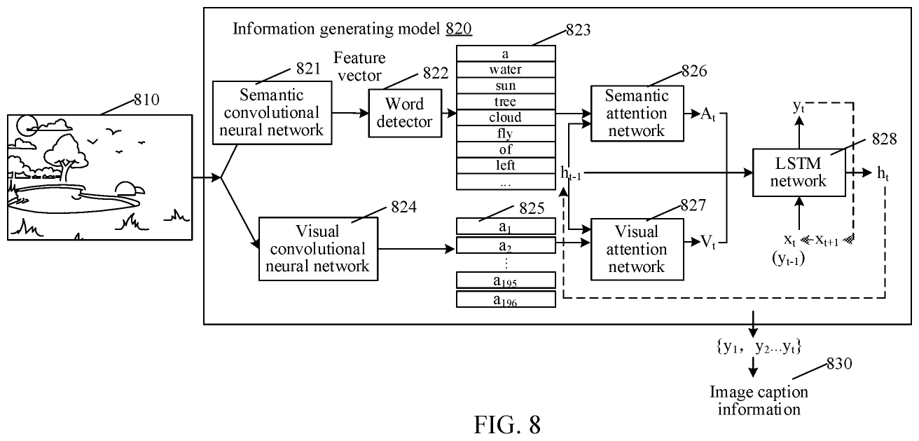

Using an example in which an attention fusion network is an LSTM network, and input of the attention fusion network includes a hidden layer vector of a previous time step, an output result of the previous time step, a visual attention vector of a current time step, and a semantic attention vector of the current time step, FIG. 8 is a schematic diagram of a process of generating image caption information according to an exemplary embodiment of this application. As shown in FIG. 8, after a computer device acquires a target image 810, the computer device inputs the target image 810 into an information generating model 820. The information generating model 820 inputs the target image 810 into a semantic convolutional neural network 821 to obtain a semantic feature vector of the target image. After that, a vocabulary detector 822 screens attribute words in the lexicon based on the semantic feature vector of the target image, obtains candidate caption words 823 corresponding to the target image, and then obtains a semantic feature set corresponding to the target image. At the same time, the information generating model 820 inputs the target image 810 into a visual convolutional neural network 824 to obtain a visual feature set 825 corresponding to the target image. The semantic feature set is inputted to a semantic attention network 826, so that the semantic attention network 826 obtains a semantic attention vector Aₜ at a current time step according to an inputted hidden layer vector outputted at a previous time step, t representing the current time step. When t=1, the hidden layer vector outputted at the previous time step is a preset hidden layer vector. Correspondingly, the visual feature set is inputted to a visual attention network 827, so that the visual attention network 827 obtains a visual attention vector Vₜ on the current time step according to the inputted hidden layer vector outputted at the previous time step. The visual attention vector Vₜ, the semantic attention vector Aₜ, the hidden layer vector outputted at the previous time step, and a caption word xₜ outputted at the previous time step (that is, yₜ₋₁), are inputted into an LSTM network 828 to obtain a caption word yₜ at the current time step outputted by the LSTM network 828. When t=1, the caption word outputted in the previous time step is a preset start word or character. Repeat the above process until the caption word outputted by the LSTM network is an end word or an end character. The computer device obtains image caption information 830 of the target image after arranging the obtained caption words in the order of obtaining.

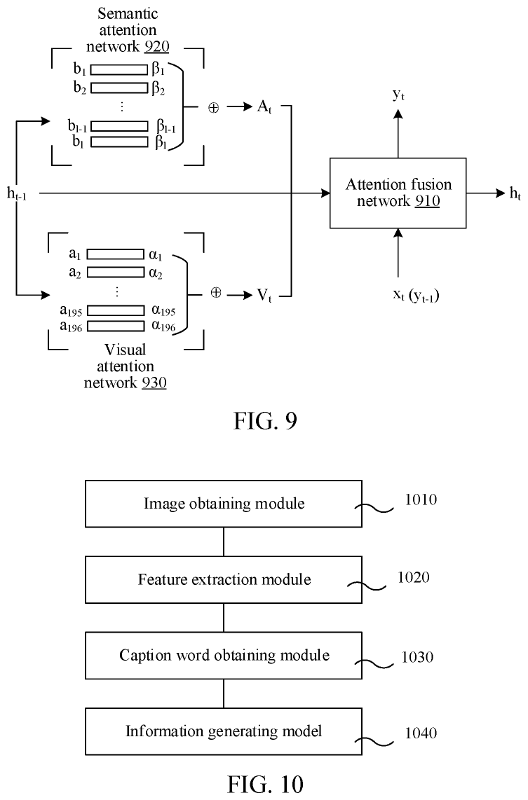

FIG. 9 is a schematic diagram of input and output of an attention fusion network according to an exemplary embodiment of this application. As shown in FIG. 9, at a t^{th} time step, input of an attention fusion network 910 includes a hidden layer vector hₜ₋₁ at a (t−1)^{th} time step, a visual attention vector Vₜ generated based on hₜ₋₁ at the t^{th} time step, a semantic attention vector Aₜ generated based on hₜ₋₁, and a graph representation vector of the caption word outputted at the (t−1)^{th} time step (that is, the output vector yₜ₋₁ at the (t−1)^{th} time step). An output of an attention fusion network 910 includes an output vector (yₜ) at the t^{th} time step, and a hidden layer vector at the t^{th} time step (hₜ, used for generating a next caption word). The visual attention vector is calculated by the visual attention network 930 based on a weighted sum of visual features corresponding to each sub-region, and the semantic attention vector is calculated by the semantic attention network 920 based on a weighted sum of each attribute word.

It can be understood that in the specific implementation of this application, user-related data such as target images are involved. When the above implementation of this application is applied to a specific product or technology, the user's permission or consent is required, and a collection, a use and a processing need to comply with relevant laws, regulations and standards of relevant countries and regions.

FIG. 10 is a frame diagram of an information generating apparatus according to an exemplary embodiment of this application. As shown in FIG. 10, the apparatus includes:
an image obtaining module 1010, configured to obtain a target image;
a feature extraction module 1020, configured to extract a semantic feature set of the target image and extract a visual feature set of the target image;
caption word obtaining module 1030, configured to perform attention fusion on semantic features of the target image and visual features of the target image at n time steps to obtain caption words of the target image at then time steps by processing the semantic feature set of the target image and the visual feature set of the target image through an attention fusion network in an information generating model, input of the attention fusion process at a t^{th} time step including a semantic attention vector at the t^{th} time step, a visual attention vector at the t^{th} time step, and an output result of the attention fusion process at a (t−1)^{th} time step, the semantic attention vector at the t^{th} time step being obtained by performing attention mechanism processing on the semantic feature set at the t^{th} time step, the visual attention vector at the t^{th} time step being obtained by performing attention mechanism processing on the visual feature set at the t^{th} time step, the output result of the attention fusion process at the (t−1)^{th} time step being used for indicating a caption word at the (t−1)^{th} time step, the t^{th} time step being any one of the n time steps, 1≤t≤n, and t and n being positive integers; and
an information generating module 1040, configured to generate image caption information of the target image based on the caption words of the target image at n time steps.

In a possible implementation, the caption word obtaining module 1030, configured to perform the attention fusion on the semantic features of the target image and the visual features of the target image at the n time steps to obtain the caption words at the n time steps by processing the semantic feature set of the target image and the visual feature set of the target image through an attention fusion network in an information generating model.

In a possible implementation, the caption word obtaining module 1030 is configured to:
input, at the t^{th} time step, the semantic attention vector at the t^{th} time step, the visual attention vector at the t^{th} time step, a hidden layer vector at the (t−1)^{th} time step, and an output result of the attention fusion network at the (t−1)^{th} time step into the attention fusion network, to obtain an output result of the attention fusion network at the t^{th} time step and a hidden layer vector at the t^{th} time step;
or,
input, at the t^{th} time step, the semantic attention vector at the t^{th} time step, the visual attention vector at the t^{th} time step, and an output result of the attention fusion network at the (t−1)^{th} time step into the attention fusion network, to obtain the output result of the attention fusion network at the t^{th} time step and the hidden layer vector at the t^{th} time step.

In a possible implementation, the attention fusion network is provided with a hyperparameter, the hyperparameter being used for indicating weights of the visual attention vector and the semantic attention vector in the attention fusion network.

In a possible implementation, the apparatus further includes:
a first generation module, configured to generate, at the t^{th} time step, the semantic attention vector at the t^{th} time step, based on the hidden layer vector at the (t−1)^{th} time step and the semantic feature set.

In a possible implementation, the first generation module includes:
a first acquisition sub-module, configured to obtain weights of each semantic feature in the semantic feature set at the (t−1)^{th} time step based on the hidden layer vector at the (t−1)^{th} time step and the semantic feature set; and
a first generation sub-module, configured to generate the semantic attention vector at the t^{th} time step, based on the weights of each semantic feature in the semantic feature set at the (t−1)^{th} time step and the semantic feature set.

In a possible implementation, the apparatus further includes:
a second generation module, configured to generate, at the t^{th} time step, the visual attention vector at the t^{th} time step, based on the hidden layer vector at the (t−1)^{th} time step and the visual feature set.

In a possible implementation, the second generation module includes:
a second acquisition sub-module, configured to obtain weights of each visual feature in the visual feature set at the (t−1)^{th} time step based on the hidden layer vector at the (t−1)^{th} time step and the visual feature set; and
a second generation sub-module, configured to generate the visual attention vector at the t^{th} time step, based on the weights of each visual feature in the visual feature set at the (t−1)^{th} time step and the visual feature set.

In a possible implementation, the feature extraction module 1020 includes:
a third acquisition sub-module, configured to obtain a semantic feature vector of the target image; and
an extraction sub-module, configured to extract the semantic feature set of the target image based on the semantic feature vector.

In a possible implementation, the extraction sub-module includes:
an attribute word extraction unit, configured to extract an attribute word set corresponding to the target image from a lexicon based on the semantic feature vector; the attribute word set referring to a set of a candidate caption word describing the target image; and
a semantic feature extraction unit, configured to obtain a word vector set corresponding to the attribute word set to the semantic feature set of the target image.

In a possible implementation, the attribute word extraction unit is configured to obtain matching probability of each word in the lexicon based on the semantic feature vector, the matching probability referring to a probability that the word in the lexicon matches the target image; and
a word whose matching probability is greater than a matching probability threshold in the lexicon being extracted as the candidate caption word, to form the attribute word set.

In a possible implementation, the attribute word extraction unit, configured to input the semantic feature vector into a vocabulary detector to obtain the attribute word set extracted by the vocabulary detector from the lexicon based on the semantic feature vector; and
the vocabulary detector being a vocabulary detection model obtained by training with a weak supervision method of multiple instance learning.

In a possible implementation, before the feature extraction module 1020 extracts the visual feature set of the target image, the apparatus further includes:
a sub-region division module, configured to divide the target image into sub-regions to obtain at least one sub-region; and
the feature extraction module 1020, configured to extract the visual features of the at least one sub-region respectively to form the visual feature set.

To sum up, the information generating apparatus provided by the embodiment of this application, by respectively extracting the semantic feature set and the visual feature set of the target image, and using the attention fusion network in the information generating model, realizes the attention fusion of the semantic features and the visual features. So that at each time step of generating the image caption information, based on the visual features and the semantic features of the target image, and in combination with the output result of the previous time step, the caption words of the target image at the current time step are generated, and the image caption information of the target image is further generated. So that in the process of generating the image caption information, the advantage of the visual features in generating visual vocabulary and the advantage of the semantic features in generating a non-visual feature are complemented, thereby improving accuracy of the generation of image caption information.

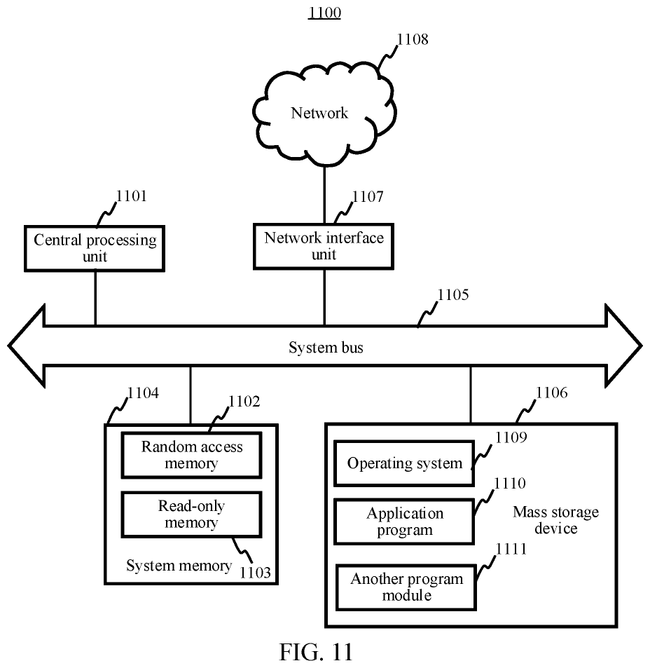

FIG. 11 is a structural block diagram of a computer device 1100 according to an exemplary embodiment of this application. The computer device can be implemented as a server in the above solutions of this application. The computer device 1100 includes a central processing unit (CPU) 1101, a system memory 1104 including a random access memory (RAM) 1102 and a read-only memory (ROM) 1103, and a system bus 1105 connecting the system memory 1104 to the CPU 1101. The computer device 1100 also includes a mass storage device 1106 configured to store an operating system 1109, an application program 1110 and another program module 1111.

In general, the computer-readable medium may include a computer storage medium and a communication medium. The computer storage medium includes a RAM, a ROM, an erasable programmable read only memory (EPROM), a flash memory or another solid-state memory technology of an electrically erasable programmable read only memory (EEPROM), a CD-ROM, a digital versatile disc (DVD) or another optical memory, a tape cartridge, a magnetic cassette, a magnetic disk memory, or another magnetic storage device. Certainly, those skilled in the art may learn that the computer storage medium is not limited to the above. The foregoing system memory 1104 and mass storage device 1106 may be collectively referred to as a memory.

The memory also includes at least one instruction, at least one segment of program, code set or instruction set. The at least one instruction, at least one segment of program, code set or instruction set is stored in the memory, and the central processing unit 1101 implements all or part of steps of an information generating method shown in each of the above embodiments by executing at least one instruction, at least one program, code set, or instruction set.

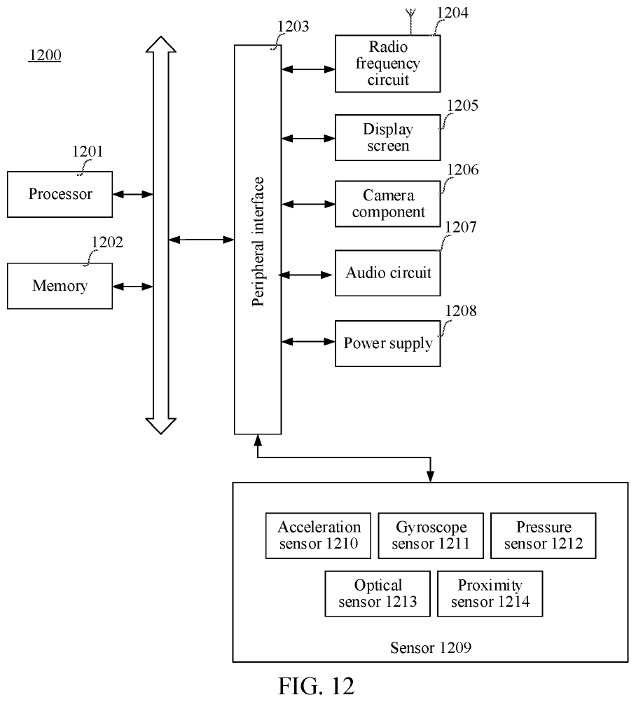

FIG. 12 is a structural block diagram of a computer device 1200 according to an exemplary embodiment of this application. The computer device 1200 can be implemented as the foregoing face quality assessment device and/or quality assessment model training device, such as: a smartphone, a tablet, a laptop or a desktop computer. The computer device 1200 may be further referred to as another name such as terminal equipment, a portable terminal, a laptop terminal, or a desktop terminal.

Generally, the computer device 1200 includes: a processor 1201 and a memory 1202.

The processor 1201 may include one or more processing cores.

The memory 1202 may include one or more computer-readable storage media that may be non-transitory. In some embodiments, the non-transitory computer-readable storage medium in the memory 1202 is configured to store at least one instruction, and the at least one instruction being configured to be performed by the processor 1201 to implement an information generating method provided in the method embodiments of this application.

In some embodiments, the computer device 1200 may also optionally include: a peripheral interface 1203 and at least one peripheral. The processor 1201, the memory 1202, and the peripheral interface 1203 can be connected through a bus or a signal cable. Each peripheral can be connected to the peripheral interface 1203 through a bus, a signal cable, or a circuit board. Specifically, the peripheral includes: at least one of a radio frequency circuit 1204, a display screen 1205, a camera component 1206, an audio circuit 1207, and a power supply 1208.

In some embodiments, the computer device 1200 further includes one or more sensors 1209. The one or more sensors 1209 include but are not limited to an acceleration sensor 1210, a gyro sensor 1211, a pressure sensor 1212, an optical sensor 1213, and a proximity sensor 1214.

A person skilled in the art may understand that the structure shown in FIG. 12 does not constitute any limitation on the computer device 1200, and the computer device may include more components or fewer components than those shown in the figure, or some components may be combined, or a different component deployment may be used.

In an exemplary embodiment, a computer-readable storage medium is further provided, storing at least one computer program, the computer program being loaded and executed by a processor to implement all or some steps of the foregoing information generating method. For example, the computer-readable storage medium may be a read-only memory (ROM), a random access memory (RAM), a compact disc read-only memory (CD-ROM), a magnetic tape, a floppy disk, an optical data storage device, and the like.

In an exemplary embodiment, a computer program product is also provided, the computer program product including at least one computer program, the computer program being loaded and executed by a processor to implement all or some steps of methods shown in any of the foregoing embodiments of FIG. 2, FIG. 6, or FIG. 7. In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

What is claimed is:

1. An information generating method performed by a computer device, the method comprising:
obtaining a target image;
extracting a semantic feature set of the target image and a visual feature set of the target image;
performing attention fusion on semantic features of the target image and visual features of the target image at n time steps to obtain caption words of the target image at the n time steps by processing the semantic feature set of the target image and the visual feature set of the target image through an attention fusion network in an information generating model; and
generating image caption information of the target image based on the caption words of the target image at n time steps.

2. The method according to claim 1, wherein the performing attention fusion on semantic features of the target image and visual features of the target image at n time steps to obtain caption words of the target image at the n time steps comprises:
inputting, at t^{th} time step, the semantic feature set at the t^{th} time step, the visual feature set at the t^{th} time step, a hidden layer vector at the (t−1)^{th} time step, and an output result of the attention fusion network at the (t−1)^{th} time step into the attention fusion network, to obtain an output result of the attention fusion network at the t^{th} time step and a hidden layer vector at the t^{th} time step;
or,
inputting, at the t^{th} time step, the semantic feature set at the t^{th} time step, the visual feature set at the t^{th} time step, and an output result of the attention fusion network at the (t−1)^{th} time step into the attention fusion network, to obtain the output result of the attention fusion network at the t^{th} time step and the hidden layer vector at the t^{th} time step.

3. The method according to claim 2, the method further comprising:
generating, at the t^{th} time step, the semantic feature set and the visual feature set at the t^{th} time step, based on the hidden layer vector, the semantic feature set and the visual feature set at the (t−1)^{th} time step.

4. The method according to claim 1, wherein the attention fusion network includes a hyperparameter for indicating weights of the visual attention set and the semantic attention set respectively in the attention fusion network.

5. The method according to claim 1, wherein the extracting a semantic feature set of the target image comprises:
obtaining a semantic feature vector of the target image; and
extracting the semantic feature set of the target image based on the semantic feature vector.

6. The method according to claim 5, wherein the extracting the semantic feature set of the target image based on the semantic feature vector comprises:
extracting an attribute word set corresponding to the target image from a lexicon based on the semantic feature vector, the attribute word set referring to a set of a candidate caption word describing the target image; and
obtaining a word vector set corresponding to the attribute word set as the semantic feature set of the target image.

7. The method according to claim 1, further comprises:
dividing the target image into sub-regions to obtain at least one sub-region; and
the extracting a visual feature set of the target image comprises:
extracting visual features of the at least one sub-region respectively to form the visual feature set.

8. A computer device, comprising a processor and a memory, the memory storing at least one computer program, and the at least one computer program being loaded and executed by the processor and causing the computer device to implement an information generating method including:
obtaining a target image;
extracting a semantic feature set of the target image and a visual feature set of the target image;
performing attention fusion on semantic features of the target image and visual features of the target image at n time steps to obtain caption words of the target image at the n time steps by processing the semantic feature set of the target image and the visual feature set of the target image through an attention fusion network in an information generating model; and
generating image caption information of the target image based on the caption words of the target image at n time steps.

9. The computer device according to claim 8, wherein the performing attention fusion on semantic features of the target image and visual features of the target image at n time steps to obtain caption words of the target image at the n time steps comprises:
inputting, at t^{th} time step, the semantic feature set at the t^{th} time step, the visual feature set at the t^{th} time step, a hidden layer vector at the (t−1)^{th} time step, and an output result of the attention fusion network at the (t−1)^{th} time step into the attention fusion network, to obtain an output result of the attention fusion network at the t^{th} time step and a hidden layer vector at the t^{th} time step;
or,
inputting, at the t^{th} time step, the semantic feature set at the t^{th} time step, the visual feature set at the t^{th} time step, and an output result of the attention fusion network at the (t−1)^{th} time step into the attention fusion network, to obtain the output result of the attention fusion network at the t^{th} time step and the hidden layer vector at the t^{th} time step.

10. The computer device according to claim 9, wherein the method further comprises:
generating, at the t^{th} time step, the semantic feature set and the visual feature set at the t^{th} time step, based on the hidden layer vector, the semantic feature set and the visual feature set at the (t−1)^{th} time step.

11. The computer device according to claim 8, wherein the attention fusion network includes a hyperparameter for indicating weights of the visual attention set and the semantic attention set respectively in the attention fusion network.

12. The computer device according to claim 8, wherein the extracting a semantic feature set of the target image comprises:
obtaining a semantic feature vector of the target image; and
extracting the semantic feature set of the target image based on the semantic feature vector.

13. The computer device according to claim 12, wherein the extracting the semantic feature set of the target image based on the semantic feature vector comprises:
extracting an attribute word set corresponding to the target image from a lexicon based on the semantic feature vector, the attribute word set referring to a set of a candidate caption word describing the target image; and
obtaining a word vector set corresponding to the attribute word set as the semantic feature set of the target image.

14. The computer device according to claim 8, wherein the method further comprises:
dividing the target image into sub-regions to obtain at least one sub-region; and
the extracting a visual feature set of the target image comprises:
extracting visual features of the at least one sub-region respectively to form the visual feature set.

15. A non-transitory computer-readable storage medium, storing at least one computer program, the computer program being loaded and executed by a processor of a computer device and causing the computer device to implement an information generating method including:
obtaining a target image;
extracting a semantic feature set of the target image and a visual feature set of the target image;
performing attention fusion on semantic features of the target image and visual features of the target image at n time steps to obtain caption words of the target image at the n time steps by processing the semantic feature set of the target image and the visual feature set of the target image through an attention fusion network in an information generating model; and
generating image caption information of the target image based on the caption words of the target image at n time steps.

16. The non-transitory computer-readable storage medium according to claim 15, wherein the performing attention fusion on semantic features of the target image and visual features of the target image at n time steps to obtain caption words of the target image at the n time steps comprises:
inputting, at t^{th} time step, the semantic feature set at the t^{th} time step, the visual feature set at the t^{th} time step, a hidden layer vector at the (t−1)^{th} time step, and an output result of the attention fusion network at the (t−1)^{th} time step into the attention fusion network, to obtain an output result of the attention fusion network at the t^{th} time step and a hidden layer vector at the t^{th} time step;
or,
inputting, at the t^{th} time step, the semantic feature set at the t^{th} time step, the visual feature set at the t^{th} time step, and an output result of the attention fusion network at the (t−1)^{th} time step into the attention fusion network, to obtain the output result of the attention fusion network at the t^{th} time step and the hidden layer vector at the t^{th} time step.

17. The non-transitory computer-readable storage medium according to claim 16, wherein the method further comprises:
generating, at the t^{th} time step, the semantic feature set and the visual feature set at the t^{th} time step, based on the hidden layer vector, the semantic feature set and the visual feature set at the (t−1)^{th} time step.

18. The non-transitory computer-readable storage medium according to claim 15, wherein the attention fusion network includes a hyperparameter for indicating weights of the visual attention set and the semantic attention set respectively in the attention fusion network.

19. The non-transitory computer-readable storage medium according to claim 15, wherein the extracting a semantic feature set of the target image comprises:
obtaining a semantic feature vector of the target image; and
extracting the semantic feature set of the target image based on the semantic feature vector.

20. The non-transitory computer-readable storage medium according to claim 15, the method further comprises:
dividing the target image into sub-regions to obtain at least one sub-region; and
the extracting a visual feature set of the target image comprises:
extracting visual features of the at least one sub-region respectively to form the visual feature set.
